(19) United States
(12) Patent Application Publication
(10) Pub. No.: US 2023/0334997 A1
(43) Pub. Date: Oct. 19, 2023

(54) SYSTEMS, APPARATUS, AND METHODS USEFUL FOR RESOURCE-EFFICIENT MACHINE-ASSISTED WIRITING COMPOSITION

(71) Applicant: THE ROIG ACADEMY, Coral Gables, FL (US)

(72) Inventor: Gustavo ROIG, Coral Gables, FL (US)

(21) Appl. No.: 18/130,898

(22) Filed: Apr. 4, 2023

Related U.S. Application Data
(60) Provisional application No. 63/332,683, filed on Apr. 19, 2022.

(51) Int. Cl. G09B 5/00; G09B 7/02

(52) U.S. Cl. CPC G09B 5/00; G09B 7/02

(57) ABSTRACT

A system useful for machine-assisted writing composition includes a prompt database configured to store prompt data for communicating to a user to solicit user input. The system includes a user input database configured to store the user input received from the user at a user interface; and a processor configured to process, store, and access information in the prompt database and the user input database, and the processor configured to cause the system to communicate with a user by a user interface to provide information to the user and receive user input to the system.

### RELATED APPLICATIONS

This application claims the benefit of priority to U.S. Provisional Application No. 63/332,683, titled SYSTEMS, APPARATUS, AND METHODS USEFUL FOR MACHINE-ASSISTED WRITING COMPOSITION, filed Apr. 19, 2022, the entire disclosure of which is hereby incorporated herein by reference.

### FIELD

The disclosure relates to systems, apparatus, and methods useful for writing composition. In particular, the disclosure relates to systems, apparatus, and methods for machine or computer-assisted writing composition that minimizes processing load and storage requirements and emphasizes user interaction over automation.

### BACKGROUND

Conventional writing composition methods exist and are varied and well developed. Most grade school curriculums in the United States of America include at least some writing composition instruction. Over the years, numerous teaching tools and aids have been developed to assist in writing composition instructions. Such aids and tools include methods and hardware, including high technology incorporating computer hardware and computer processing.

For example, many American grade schools and grade school teachers providing writing composition instruction rely on the standard five-paragraph essay form as a useful teaching tool. This teaching tool helps students understand writing composition through a form having about five paragraphs: introductory, three or more body paragraphs, and one conclusion paragraph. Students can use this conceptual tool and format to learn writing composition building blocks, including learning to develop and communicate a thesis, provide support for the thesis in an organized manner, and provide a conclusion. Command over the five paragraph form typically enables students to advance in writing composition skill and difficulty, and to produce more complex documents and communicate more complex ideas.

Such conventional methods for teaching writing, while accepted and proven to be widely useful, are not without their perceived shortcomings. Even use of the five-paragraph form has critics in pedagogy. Some consider this teaching device to restrict idea development. The five paragraph form is nonetheless widely understood to at least be useful for initially developing analytical skills and writing composition skills, particularly organization skills for effective communication.

Machine-assisted essay composition has been long been a sought after solution for improved writing composition teaching tools. For example, the related art includes various systems and methods for producing a college application essay that leverage computer technology. Some related art systems and methods include an interactive system and method for drafting a college admissions essay wherein systems are configured to provide a series of instructional videos at a computer system and monitor for creating an engaging essay based on universal story telling principles. The system uses an application module programmed to provide a structured series of opportunities for a student participant to input relevant text specific to the college application process to aid the user in completing a college application including a narrowly applicable statement reflecting information typically included in a college application.

Such related art systems provide assistance in essay composition in general, and particularly assistance in composing college admission essays for students by suggesting topics, asking questions of a student according to a script, and compiling the answers to produce. For example, one essay writing system for teaching writing to students is configured to prompt the student to provide input for a thesis statement on a display, and then prompt the student to provide, a topic sentence, and a conclusion sentence. The system then generates a color-coded draft essay. Thus, systems exist that include a computer-based system for composing an essay comprising at least one computer-readable medium having one or more executable instructions stored thereon, which when executed by at least one processing system, causes the at least one processing system to implement one or more limited essay generation tools for assisting a user in generating an essay, such as automated color coding and prompting for titles and topic sentences.

Other systems exist that provide yet further assistance beyond tools with limited usefulness. For example, one related art system, method, and a computer program product is configured for generating or preparing documents and includes at least one processor in a computing system that receives at least one parameter relating to a document. The processor generates at least one narrative based on the received parameter, which is based on information stored in a database and accessed by the processor. Such systems are used for compiling college application documents and the like. For example, such systems are configured to support researching information, using one or more databases. The information obtained by searches can be saved to a dashboard that can take the form of a user interface displayed to the user. For example, in a system where searches relate to college application and admission processes, the dashboard can include requirements, deadlines, notes, etc., related to one or more colleges that the user is interested in. The processor then generates at least one document mapping based on the generated narrative by combining the generated mapping and the generated narrative to generate the document for review by the user.

Thus, such related art systems rely on significant use of databases, memory, and processing steps to automatically generate a complete pre-formatted communication in a document using information retrieved from the database(s) and user input. For example, the related art system and methods for facilitating college application document generation creates a narrative through use of dynamic content as well as employing sequenced interactive exercises. The systems and methods include steps of identifying a moment; recording a story to create a first draft; organizing the story using a three-sentence map; evaluating content that fits into the map; and replacing thoughts, interpretations, judgments, etc., with details, dialogue, description, etc. to generate a narrative.

Specifically, the related art college application system is configured to issue a prompt to a user at a user interface to determine a type of document to generate. Document types may include a defining moment, influence, issue, or reason why a particular college or major is important. The system is configured to identify a moment by prompting the user to select a trait to explore based on personality types stored in the system. Once the trait is selected, the user can be presented with a plurality of images stored in the system that represent different ways the trait can be revealed through action. The user can select an image that best represents how the user brings the trait to life. Then, the system prompts the user to identify a moment in the user's own life when the user has shown this trait. The user can be presented with example moments and guiding questions that can be dynamic based on the selected trait. The use can then write about the moment further in a predetermined number of characters. Finally, the system creates a draft. The system can create documents using maps stored in one or more databases.

Similarly, other elated art systems and methods are configured for educating writers in the preparation of written work and require complex processes and hardware strcuture including appropriate database configurations and storage space. An example related art system includes processes such as identifying a writing structure, composition styles, and instructing the user through use of the writing structure and composition styles identified. The system guides the user's composition while the composition is being entered. The system checks the finished draft for writing structure, composition correction, and composition style features and allows the writer to modify the composition.

### SUMMARY

It has been recognized that a need exists for a writing composition system that assists a broader range of students and writers. In particular, while conventional writing composition methods are known and widely used and accepted, a need exists for a technological solution to address shortcomings of conventional methods for teaching writing composition and assisting writers, including accommodating the myriad ways different individuals learn and visualize information, and process ideas in the abstract in preparation for communicating those ideas in written form.

In particular, the disclosure relates to systems, apparatus, and methods for machine or computer-assisted writing composition that minimizes processing load and storage requirements and emphasizes user interaction over and user-originated composition over mere automation.

Solutions are provided herein to address these challenges by leveraging computer systems, electronic displays, user input interfaces, and related computer systems and electronic devices configured to aid a user in idea organization and written composition while minimizing power and resource needs. Whereas conventional methods for teaching writing composition may be useful to many people, other people may benefit and even need assistance in organizing ideas or beginning or continuing to complete the writing process, or working out an effective structure for communicating ideas. The machine-assisted solutions disclosed herein meet a two-pronged need to improve on related art systems and methods. In particular, the machine-assisted solutions include a combination of features that synergistically enhance teaching utility while improving technical efficiency by enabling said teaching to be accomplished through reduced hardware and resource needs, including less processing requirements and storage requirements than conventional systems. Further, the systems and methods disclosed herein facilitate sufficient user participation to cause the user to remain actively involved in the composition of the document, rather than passively providing answers to a computer system that then automatically aggregates the inputs or compiles the user provided information to compose a document without exercising the user's writing skills.

The past several decades have witnessed a proliferation in computer technology. In embodiments of systems, apparatus, and methods of the disclosure, now known and later developed computer components and software are configured to assist users in writing composition. In an embodiment of systems, a computer processor, memory, a user interface device, and a user display and/or audio device are configured to execute a computer-assisted writing composition process. By example, such a configuration enables enhanced use of the five paragraph form device by relying on computer assistance for idea generation, organization, and facilitating user writing composition through visual display and computer-user interaction with user interface(s) and display device(s) and/or audio devices.

In embodiments, a computer and connected display and user interface(s) are configured to execute computer readable instructions provided on a computer readable medium. The computer readable instructions include processes to be carried out by the computer. The processes correspond to steps in a method for computer-assisted writing composition and may include displaying to a user on a display device a user prompt to enter, using the user interface(s), information such as document title, an idea(s), a thesis, a supporting paragraph, a conclusion, a topic sentence, a supporting sentence, and various other components that are usable for forming a complete written document.

The steps of the method include steps pertaining to the computer interrogating the user through displayed prompts to enter information in a sequence or series of user-computer interactions designed to optimize ease of idea formation, memorialization, organization, paragraph and sentence composition, and conclusion formation. A user may enter the information in response to displayed prompts, thereby triggering a responsive event by the computer and associated display and user interface(s) toward a complete written document. For example, the user may be prompted to enter additional information, or may be prompted to instruct the computer to cause the computer generate a document based on the user-entered information and to display the generated document on the display device.

The information entered by the user at the user interface(s) is stored in memory. The stored information is retrieved and processed by now known or later developed methods whereby a processor causes processing of the retrieved information to determine components of a complete written composition, and to determine an order of said determined components of information, and to compile the complete written composition by arranging the components according to the order and according to user input. The processing includes communicating the compiled complete written composition by way of a user interface and/or an audio device and/or a display device such as a computer monitor or other electronic display connected to the computer processor for receiving data for display. For example, the methods include causing the processor to display by the display device the prompts for interrogation and receipt of user provided responses by a user interface, and display input information, determined components and order of said components, and arrangement of said components.

In one embodiment, a system useful for machine-assisted writing composition includes a prompt database configured to store prompt data for communicating to a user to solicit user input; a user input database configured to store the user input received from the user at a user interface; and a processor configured to process, store, and access information in the prompt database and the user input database, and the processor configured to cause the system to communicate with a user by a user interface to provide information to the user and receive user input to the system.

In one embodiment, a method includes providing, by a processor communicating with a database, a user input portal to a user; prompting the user to input predetermined information sets; receiving, by the processor, the predetermined information sets at the system; processing, by the processor, the received user input information sets and storing the same in a database according to a respective information set; and compiling, by the processor, the stored information to produce a draft document.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a diagrammatical plan view of systems in accordance with an exemplary embodiment;

FIG. 2 shows machine-based methods in accordance with an exemplary embodiment;

FIG. 3 shows machine-based methods in accordance with an exemplary embodiment.

### DETAILED DESCRIPTION

Exemplary embodiments are intended to cover all alternatives, modifications, and equivalents as may be included within the spirit and scope of the systems, apparatus, and methods as described herein.

Reference is made to the drawings to accommodate understanding of systems, apparatus, and methods for machine or computer-assisted writing composition that minimizes processing load and storage requirements and emphasizes user interaction over automation. In the drawings, like reference numerals are used throughout to designate similar or identical elements. The drawings depict various embodiments of illustrative systems, apparatus, and methods for machine or computer-assisted writing composition useful for teaching writing composition to students.

Systems, apparatus, and methods for machine or computer-assisted writing composition that minimize processing load and storage requirements and emphasizes user interaction over automation for teaching writing composition are provided. Embodiments of systems, apparatus, and methods are disclosed herein.

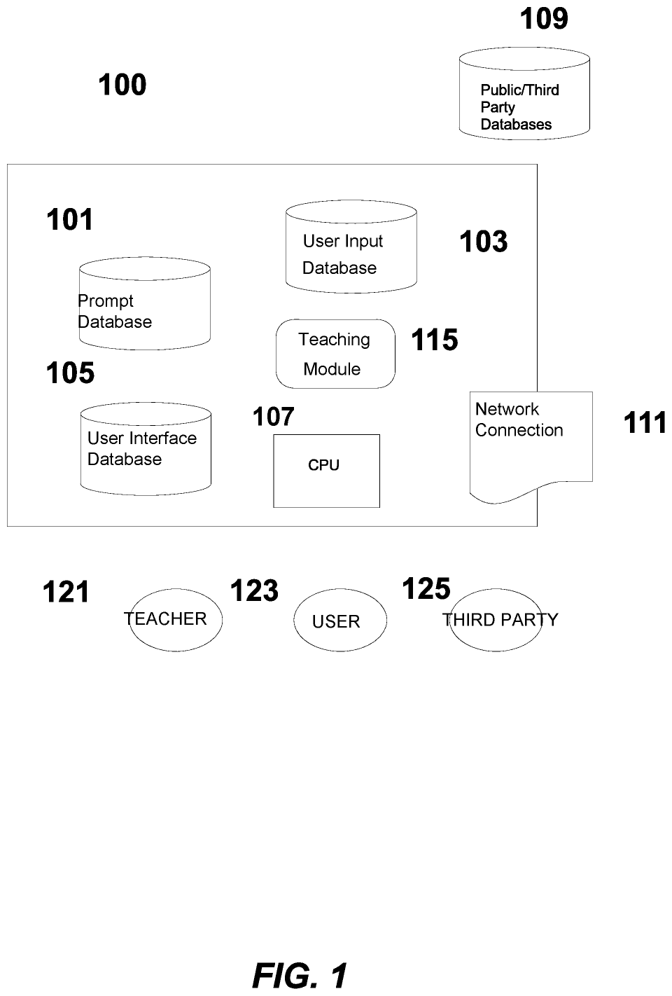

FIG. 1 shows a computerized system 100 for machine-assisted composition useful for teaching a writing composition student user. The system 100 may be a local contained system include display for communicating with a user. In other embodiments, the system 100 may be connected to a local or wide area network. The system 100 may be configured for single user operation. In other embodiments, the system 100 may be configured for use by multiple parties. For example, the system 100 may be configured for use by a teacher, a student user, a parent or guardian, and/or a teaching organization or school.

As shown in FIG. 1, systems of embodiments include a processor and a database for storing information provided by a user. In particular, the system 100 includes a prompt database 101, a user input database 103, a user interface database 105, and a processor or CPU 107. The prompt database 101, the user input database 103, and the user interface database 105 may be one or more databases, separate or combined, local or remote. In some embodiments, the system 100 includes these features in a local device such as a desktop computer, a smartphone, or a self-contained electronic apparatus including a display or audio capability. In some embodiments, the system 100 includes a network connection 111. The system 100 may be connected to a public or third/party database 113 for retrievable storage of user information.

The system 100 includes a teaching module 115. The teaching module 115 is configured to execute processes in accordance with embodiments of methods provided by this disclosure. A teacher device 121, a user device 123, and/or a third party device 125 may communicate with the system 100 by the network connection 111. The user may interact with the system 100 from a user device 123, or a display and user interface (not shown) directly connected to the system 100.

In an embodiment, the database(s) are one or more memory storage devices or systems formed of any suitable now know or later developed components and methods. Individual system components such as memory storage devices, controllers or processors, communications interfaces, receivers, transceivers, and the like are known. Later developed system components may be implemented for forming systems while in accordance with embodiments and the scope and spirit of the disclosure.

The prompt database 101 is configured for storing information based on which the system 100 communicates a prompt to a user by a display. The prompt interrogates the user to input responsive information such as titles, topics, ideas, and introduction or conclusion sentences, for example.

The user input database 103 is configured for storing information provided by the user. For example, a user may provide information responsive to a prompt communicated to the user by a display. The user may input the responsive information by a user interface connected to or in communication with the system 100. The user information may be received by the system 100, processed by the CPU 107, and stored in the user input database 103 for later retrieval.

The user interface database 105 is configured for storing user interface information. In particular, the CPU 107 may be configured to generate and communicate by display to a user by way of a user interface. The components of the user interface are stored in the user interface database 105.

The public/third party database 109 may be configured for storing and providing for access updates or libraries or additional features such as guidance content or other teaching assistance features. The network connection 111 may facilitate communication between the system 100 and remotely located public/third party databases 109.

The processing of user input information in response to user prompts displayed to a user is caused by one or more processors. FIG. 1 shows a processor CPU 107. The processor CPU 107 is configured to deliver prompts to a user of the system 100 by a combination of using the prompt database 101, the user input database 103, and the user interface database 105. The CPU 107 is configured to receive and process inputs by the user responsive to the prompts displayed on a display to the user and using a user interface. The user interface is formed and operated using the user interface database 105 and provided on a display (not shown) for the user to view and interact with by user input at the user interface. The display and user interface user end components may be formed of any suitable now known or later developed components, as may any of the individual components that may be used to form the system 100 and the components used to interact with the system 100.

For example, a teach, a user, or a third party may interact with the system 100 by way of the network connection 111 from a user end device, 121, 123, and 125 respectively. The user end device may be a desktop computer, a web page, a smartphone, or any similar device constructed and configured to provide a display and accommodate a user interface. The system 100 includes a teaching module 115.

The teaching module 115 is configured to cause the processor to execute machine readable instructions to interact with the various one or more databases, prompt a user by a display and user interface, and receive and process information input by the user. The teaching module 115 is configured to cause the processor to receive, process, and store the user input information. The teaching module 115 is configured to cause the processor to interrogate the user accordingly for specific pieces of information that are received, stored, and used to form a complete rough draft document that is presented by display to the user or by other communication to the user.

The teaching module 115 is configured in some embodiments to provide teaching aids to a user in the form of revision suggestions, hints, or proofreading assistance. The teaching module 115 is configured to display information input by the user for enhanced organization of document components during the course of composing a document. For example, the teaching module 115 may be configured to present a document “map” outlining the completed portions of a document or otherwise identifying document components and communicate the same for display to the user.

The teaching module 115 is configured to interrogate the user in a stepwise fashion to obtain from the user the components of a document. The teaching module 115 is configured to process the received user input information and to present the information by display to the user in a manner that affords enhanced understanding of the organization, structure, and content of the document. The teaching module 115 is configured in some embodiments to facilitate reorganization and editing of the document at the display and by a user interface. For example, the teaching module 115 may be configured to enable “drag and drop” of document components such as paragraphs or sentences.

The teaching module 115 is configured in some embodiments to prompt a user to provide key document components such as a title, topic sentences, ideas, and details for ideas. The teaching module 115 is configured to cause the processor to execute instructions that cause the system to prompt the user for such information, receive, process, and store the information, and present futher prompts and display interfaces using the stored information. For example, the system 100 may be configured to prompt the user to input ideas, and may present the input ideas to the user by display in a manner that enhances the user's organization understanding of the ideas presented, and permitting reorganization of order and content of the ideas thus far input.

The system 100 may be configured to then prompt the user to input details concerning the ideas. The system may present the ideas and respective input details as a series of paragraphs forming the body of a document. The system 100 may be configured to then prompt the user to input topic and/or conclusion sentences, and to assist the user by using further user input and/or information stored in the one or more databases to compile introduction, conclusion, and/or body paragraphs. Thus, the system 100 is configured to provide a synergistic combination of machine-assistance by visual feedback and organizational support, and minimalist guidance that leads the writer to produce the document, rather than produces the document for the writer. The result is an effective and lean machine-assisted writing system that enhances user learning while optimizing a technical efficiency of the system 100 relative to related art systems.

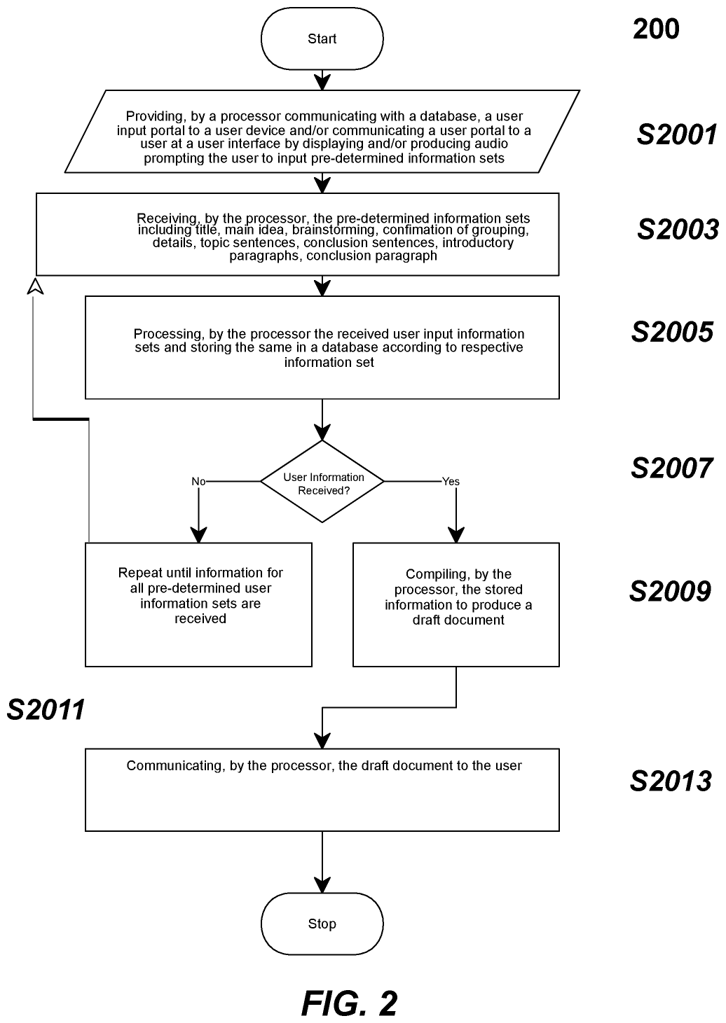

FIG. 2 shows processes for machine-based methods in accordance with an exemplary embodiment. In particular, FIG. 2 shows a method 200. The method 200 may be implemented, for example, using the system 100 shown in FIG. 1.

FIG. 2 shows the method 200 includes a step S2001 of providing, by a processor communicating with a database, a user input portal to a user device and/or communicating a user portal to a user at a user interface by displaying and/or producing audio prompting the user to input pre-determined information sets.

The method 200 includes a step S2003 of Receiving, by the processor, the pre-determined information sets including title, main idea, brainstorming, confimation of grouping, details, topic sentences, conclusion sentences, introductory paragraphs, conclusion paragraph.

The method 200 includes a step S2005 of processing, by the processor the received user input information sets and storing the same in a database according to respective information set. Then, the method 200 includes a step S2007 of determining whether information queried and/or all information necessary to compile the complete document has been received from the user.

If the step S2007 results in a determination that no further information is required, then S2009 includes a step of repeating the process steps S2003 and S2005 until all necessary or predetermined requisite components of information are received.

If the step S2007 results in a determination that further information is required, then S2011 includes a step of compiling, by the processor, the stored information to produce a draft document. After the document is compiled, the process shown in FIG. 2 includes communicating, by the processor, the draft document to the user.

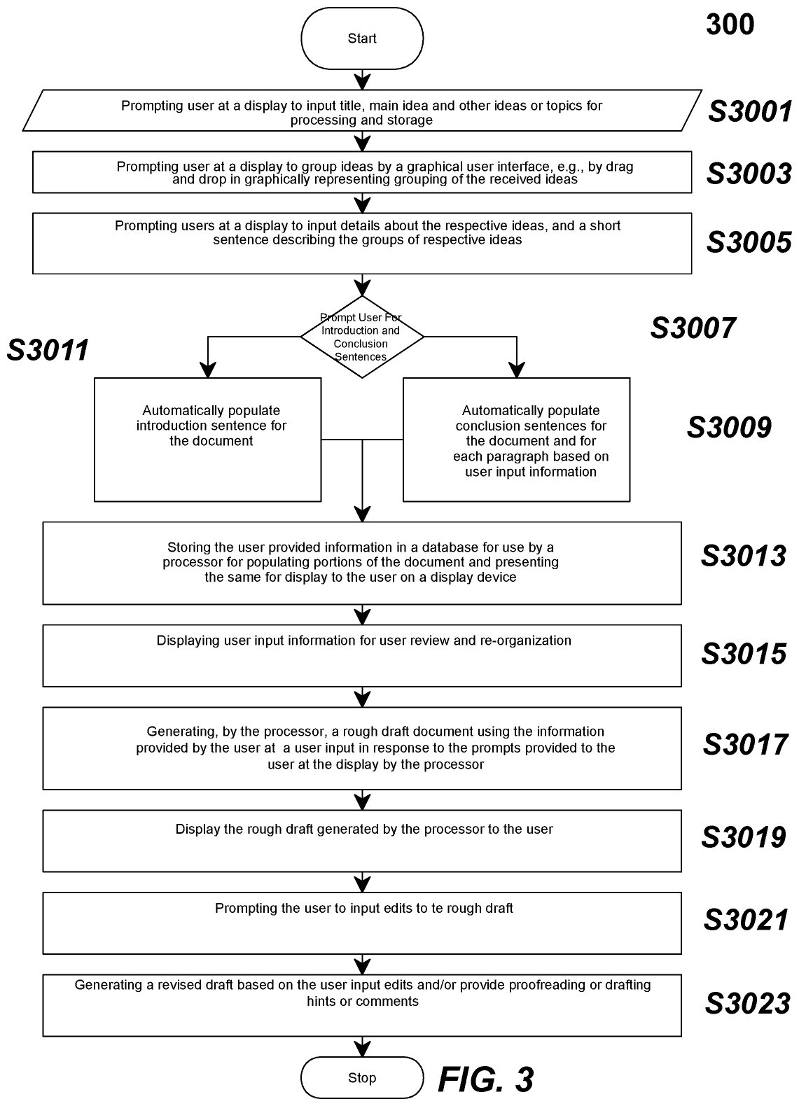

FIG. 3 shows processes for machine-based methods in accordance with an exemplary embodiment. In particular, FIG. 3 shows a method 300. The method 300 may be implemented, for example, using the system 100 shown in FIG. 1.

FIG. 3 shows the method 300 includes a step S3001 of prompting user at a display to input title, main idea and other ideas or topics for processing and storage.

The method 300 includes a step S3003 of prompting user at a display to group ideas by a graphical user interface, e.g., by drag and drop in graphically representing grouping of the received ideas. Alternatively, or in combination, the method 300 includes a S3005 of prompting users at a display to input details about the respective ideas, and a short sentence describing the groups of respective ideas.

The method 300 includes at S3007 prompting user for introduction and conclusion sentences. Then, the method 300 includes at S3009 automatically populating conclusion sentences for the document and for each paragraph based on user input information. Further, the method 300 includes at S3011 automatically populating introduction sentence for the document.

The method 300 includes at S3013 storing the user provided information in a database for use by a processor for populating portions of the document and presenting the same for display to the user on a display device. Then, the method includes at 53015 displaying user input information for user review and re-organization.

Then, the method 300 includes at 53017 generating, by the processor, a rough draft document using the information provided by the user at a user input in response to the prompts provided to the user at the display by the processor. The method includes displaying the rough draft to the user at S3019.

The user may be prompted at S3021 to input edits to the displayed rough draft. The method 300 may include at S3023 generating a revised draft based on the user input edits and/or provide proofreading or drafting hints or comments.

For example, in some embodiments, the system is configured to assist with proofreading without sacrificing user writing and editing experience. In particular, the system may be configured to automatically determine spelling, grammar, or other errors. The system may be configured to present a user interface for display to a user wherein the user interface communicates the errors while requiring the user to enter input or edit the document to correct the errors. The system may be configured to present a user interface and prompt sequence that progressively limits other features, such as assisting with identification and organization of input ideas through the drag and drup functionality.

In some embodiments, the system is configured to remove assistance and/or tools from a user's access as the user progresses in system use. For example, the system may be configured to limit tools to a user under certain circumstances. One embodiment may include a teaching module configured to reduce a number of tools available by, for example, obviating a step of communicating a user prompt intended to elicit a particular response, obviating a step of offering proofreading or grammar assistance, and/or causing the system

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system useful for machine-assisted writing composition, comprising:
a prompt database configured to store prompt data for communicating to a user to solicit user input;
a user input database configured to store the user input received from the user at a user interface; and
a processor configured to process, store, and access information in the prompt database and the user input database, and the processor configured to cause the system to communicate with a user by a user interface to provide information to the user and receive user input to the system.

2. The system of claim 1, comprising:
a user interface database configured to store and provide for access user interface information for providing a user interface.

3. The system of claim 2, the processor configured to cause the system to provide a user interface for use by a user, the user interface provided based on the user interface information stored in the user interface database.

4. The system of claim 3, comprising:
a teaching module comprising computer-readable instructions, the processor configured to cause, according to the computer-readable instructions, the system to communicate prompts to a user, receive responsive user input, process the user input, and store the user input in the user input database, compile a document based on the user input, and communicate the document to the user.

5. The system of claim 1, comprising:
a display.

6. The system of claim 4, comprising:
a display, the teaching module configured to communicate the prompt and the document to the user by the display.

7. The system of claim 1, comprising:
a third party database.

8. The system of claim 1, comprising:
a network connection.

9. The system of claim 8, comprising:
a teacher device connected to the system by the network connection;
a user device connected to the system by the network connection; and
a third party device connected to the system by the network connection.

10. A method, comprising:
providing, by a processor communicating with a database, a user input portal to a user;
prompting the user to input predetermined information sets;
receiving, by the processor, the predetermined information sets at the system;
processing, by the processor, the received user input information sets and storing the same in a database according to a respective information set; and
compiling, by the processor, the stored information to produce a draft document.

11. The method of claim 10, comprising:
communicating the draft document comprising the compiled information to the user.

12. The method of claim 11, comprising:
displaying the draft document on a display.

13. The method of claim 12, the displaying further comprising displaying the draft document on a display at a user device remotely located from the system, the system comprising a network connection configured to facilitate networked communication between the system and the user device.

14. The method of claim 10, comprising:
storing the user provided information in a database for use by a processor for populating portions of the document and presenting the same for display to the user on a display device.

15. The method claim 10, comprising:
displaying the user input information for user review and re-organization by the user interface.

16. The method of claim 10, comprising:
generating by the processor the rough draft document using the information provided by the user at the user interface in response to prompts stored and served from a user prompt database.

17. The method of claim 10, comprising:
displaying the rough draft to the user at a display local to the system.

18. The method of claim 10, comprising:
generating a revised draft based on the user input edits and/or provide proofreading or drafting hints or comments for review by the user.
